(19) United States
(12) Patent Application Publication
(10) Pub. No.: US 2004/0243882 A1
(43) Pub. Date: Dec. 2, 2004

(54) System and method for fault injection and monitoring

(75) Inventor: Charles J. Zhou, Mountain View, CA (US)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc.

(21) Appl. No.: 10/445,700

(22) Filed: May 27, 2003

(51) Int. Cl. H04B 1/74

(52) U.S. Cl. 714/38

(57) ABSTRACT

A system and method for validating error-handling code by fault injection. In one embodiment, the system may include a software module operable to communicate with a function provider configured to provide designated functions in response to calls initiated by the software module. The system may further include an error handling block configured to respond to a plurality of error conditions, and a fault injection layer operable to intercept a function call generated by the software module. The fault injection layer may thereby prevent a corresponding function from being performed by the function provider, and instead return an error condition in response to the function call.

### BACKGROUND OF THE INVENTION

1. Field of the Invention

This invention relates to the field of computer system error handling and detection and, more particularly, to a system and method for providing fault injection to verify the error handling capabilities of a software system.

2. Description of the Related Art

Most modern computer software must provide two basic types of functionality: the core functionality of the software in question, and error-handling functionality designed to deal with any non-standard behavior encountered by the software. For example, a program may be expected to gracefully handle errors caused by, for example, incomplete or garbled instructions received from an end user or scrambled data received from a peripheral device.

For reliability purposes, most or all the functionality of a software application must be verified by testing. Because the core functionality of each piece of software is different, the methodology used for the testing of such core functionality is often developed in parallel with the application. However, various tools and techniques such as automated scripting and result analysis, for example, may help to streamline the core functionality testing process.

Testing error-handling functionality may be considerably more difficult in comparison to testing core functionality, since the number of possible errors may often be far greater than the number of valid scenarios. For example, a hardware driver may be configured to execute only a handful of standard routines in normal operation but execute many times more error handling routines in various atypical situations.

The error-handling functionality of a program may be broken up into multiple error-handling blocks, each operable to handle the errors associated with a single function or a single type of error. However, while such error-handling blocks may comprise a significant portion of the program code, they may be accessed sporadically or not accessed at all during regular operation of the program, due to the relative scarcity of errors. Furthermore, simulating an error such as a specific hardware device failure may be difficult to precisely reproduce or automate.

One method of simulating errors is fault injection. Fault injection may be hardware- or software-based, and may involve scrambling, inverting, replacing, or otherwise modifying digital values within the computer. For example, a software-based fault injection mechanism may be operable to overwrite application data in a computer's main memory. Alternatively, a hardware-based fault injection mechanism may flip random bits in a register within a computer's CPU.

However, these fault-injection methods may be inappropriate for testing a specific application's error handling abilities. The effects of an injected error may be nearly impossible to predict or determine after the fact. For example, an injected bit-flip may have no effect on an application, or may cause an error in the operating system. Furthermore, the space of possible errors that may be injected at various times during an application's execution is nearly infinite. It may therefore be difficult to test the error-handling functionality of a single application using standard fault injection methodology.

### SUMMARY OF THE INVENTION

Various embodiments of a system and method for validating error-handling code by fault injection are disclosed. In one embodiment, the system may include a software module operable to communicate with a function provider configured to provide designated functions in response to calls initiated by the software module. The system may further include an error handling block configured to respond to a plurality of error conditions, and a fault injection layer operable to intercept a function call generated by the software module. The fault injection layer may thereby prevent a corresponding function from being performed by the function provider, and instead return an error condition in response to the function call.

### BRIEF DESCRIPTION OF THE DRAWINGS

FIG. 1 is a block diagram of one embodiment of a computer system.

FIG. 2 is a functional block diagram illustrating one embodiment of a user application and associated software and hardware components.

FIG. 3 illustrates one embodiment of a fault injection layer operating in transparent mode.

FIG. 4 illustrates one embodiment of fault injection layer operating in non-transparent mode.

FIG. 5 is a flowchart illustrating one embodiment of a method for systematically testing the functionality of error handling blocks.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

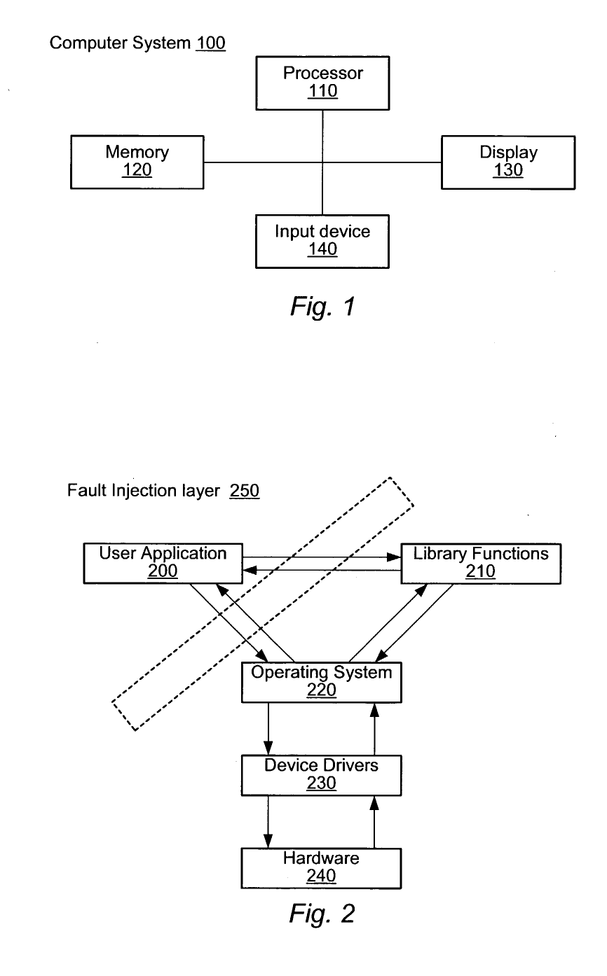

Turning now to FIG. 1, block diagram of one embodiment of a computer system 100 is shown. Computer system 100 includes a processor 110 coupled to a memory 120, a display 130, and an input device 140. It is noted that computer system 100 may be representative of a laptop, desktop, server, workstation, terminal, personal digital assistant (PDA) or other type of system.

Processor 110 may be representative of any of various types of processors such as an x86 processor, a PowerPC processor or a CPU from the SPARC family of RISC processors. Similarly, memory 120 may be representative of any of various types of memory, including DRAM, SRAM, EDO RAM, Rambus RAM, etc., or a non-volatile memory such as a magnetic media, e.g., a hard drive, or optical storage, for example. It is noted that in other embodiments, the memory 120 may include other types of suitable memory as well, or combinations of the memories mentioned above.

Display 130 may be representative of any of various types of displays, such as a liquid crystal display (LCD) or a cathode ray tube (CRT) display, for example. As shown in FIG. 1, computer system 100 may also include an input device 140. The input device 140 may be any type of suitable input device, as appropriate for a particular system. For example, the input device 140 may be a keyboard, a mouse, a trackball or a touch screen.

As will be described in greater detail below in conjunction with FIGS. 2-5, processor 110 of computer system 100 may execute software configured to validate error-handling code by fault injection. The fault injection software may be stored in memory 120 of computer system 100 in the form of instructions and/or data that implement the operations described below.

Turning now to FIG. 2, a functional block diagram illustrating one embodiment of a user application and associated software and hardware components residing on computer system 100 is shown. User application 200 may provide any of a wide variety of functionality, including but not limited to scientific applications, multimedia applications, productivity applications, system utilities, or Internet applications, for example. User application 200 communicates with library functions 210 and operating system 220 by a programming interface of function calls and return values, as will be described below. Likewise, library functions 210 and device drivers 220 are also connected to operating system 220 through a programming interface.

Library functions 210 typically comprise one or more library components providing a wide variety of functionality, including, but not limited to, various input/output library functions, text parsing algorithms, memory-management routines, or numerical functions, for example.

Operating system 220 may be operable to provide one or more programs running on computer system 100 with access to various system functions as desired. Operating system 220 may be representative of various operating systems, including Solaris by Sun Microsystems, Linux, or Windows XP.

Device drivers 230 may be operable to control hardware 240 through various memory writes and/or manipulation of input/output bridges connected to hardware 240, in accordance with instructions issued by operating system 220. Hardware 240 may be a network adapter, a graphics card, a hard drive, a removable media drive, or any kind of peripheral, for example.

A programming interface may include one or more functions which reside on one software module and are called by another software module. For example, as described above, user application 200 may call one or more functions in operating system 220 by passing in one or more input parameters and receiving one or more output parameters, including a return value. In one embodiment, a called function may change the state of or control a distant component, such as hardware 240. Alternatively, a called function may perform processing on various input parameters and return one or more output parameters.

Fault injection layer 250 may be coupled to the interface(s) between user application 200, operating system 220 and library functions 210, as shown in FIG. 2. Fault injection layer 250 may be operable to intercept function calls made between user application 200, operating system 220 and library functions 210.

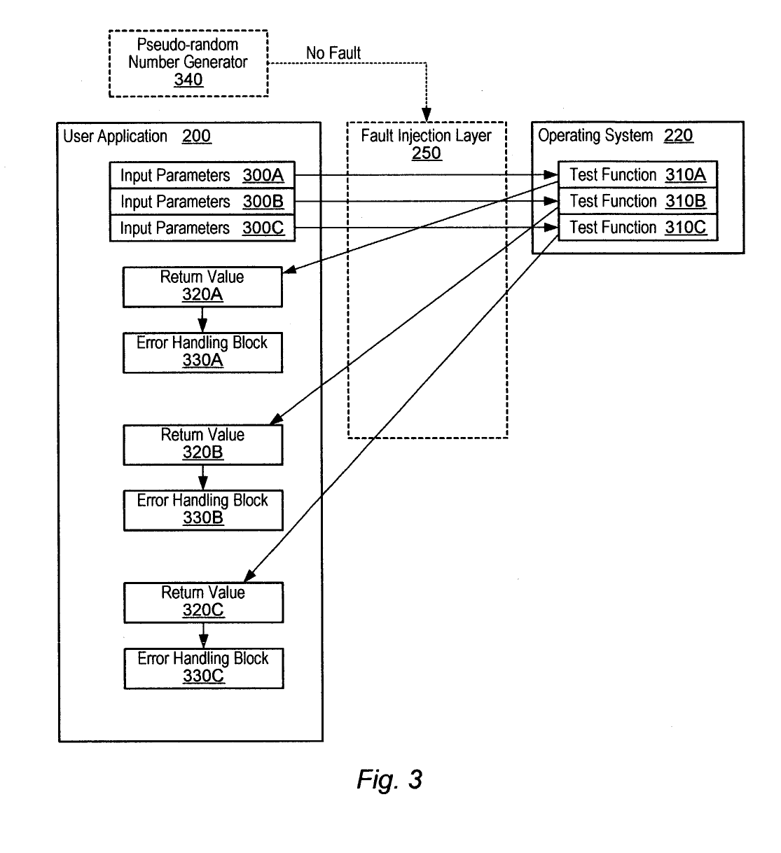

Turning now to FIG. 3, further aspects of one implementation of the interface between user application 200 and operating system 220 are shown. In the depiction of FIG. 3 it is assumed that fault injection layer 250 is operating in a transparent mode. In one embodiment, when operating in transparent mode, fault injection layer 250 does not interfere with the functional interactions between software modules (i.e. the fault injection functionality of fault injection layer 250 is disabled).

As illustrated in FIG. 3, user application 200 is operable to pass input parameters 300A-C through fault injection layer 250 to respective test functions 310A-C provided by operating system 220. In response, test functions 310A-C are operable to pass return values 320A-C back through fault injection layer 250 to user application 220. User application 220 may then pass return values 320A-C to error handling blocks 330A-C.

Error handling blocks 330A-C may be operable to interpret and act upon any error conditions passed back as return values 320A-C from functions 310A-C. In one embodiment, return values 320A-C may be operable to indicate any of a wide variety of error conditions associated with the respective test functions 310A-C, including a “no error” condition.

Likewise, in one embodiment, error handling blocks 330A-C may be operable to handle any potential error conditions indicated by return values 320A-C by communicating through user application 220. For example, test function 310A may be part of a programming interface for hardware 240, which may be, in one embodiment, a network adapter, for example. Continuing the above example, return value 320A may indicate that hardware 240 is inoperable, thereby causing error handling block 330A to provide a user indication that hardware 240 is inoperable through user application 220. Return value 320A may alternatively provide an indication that a send buffer is full in hardware 240, thereby causing error handling block 330A to temporarily suspend data transfer from user application 220 to hardware 240, for example. Return value 320A may alternatively provide an indication that no error has occurred in test function 310A, thereby causing no action to occur in error handling block 330A, in one example.

It is noted that in various embodiments, operating system 220 may contain any number of test functions 310A-C. Likewise, user application 200 may contain any number of error handling blocks 330A-C. In one embodiment, each test function 310A-C may have a single associated error handling block 330A-C. In an alternate embodiment, each test function 310A-C may have multiple error handling blocks 330A-C, with each error handling block 330A-C assigned to cover one or more possible error conditions from a set of all possible error conditions associated with each test function 310A-C.

It is further noted that in one embodiment, an error handling block 330A-C may service multiple test functions 310A-C. It is also noted that each test function 310A-C may have a unique number of error conditions, and that various error conditions may have different meanings for different test functions 310A-C, and cause different actions in error handling blocks 330A-C.

FIG. 3 further illustrates pseudo-random number generator 340. In one embodiment, pseudo-random number generator 340 is operable to generate a pseudo-random number that may be used to control whether fault injection layer operates in a transparent or in a non-transparent mode, as discussed below.

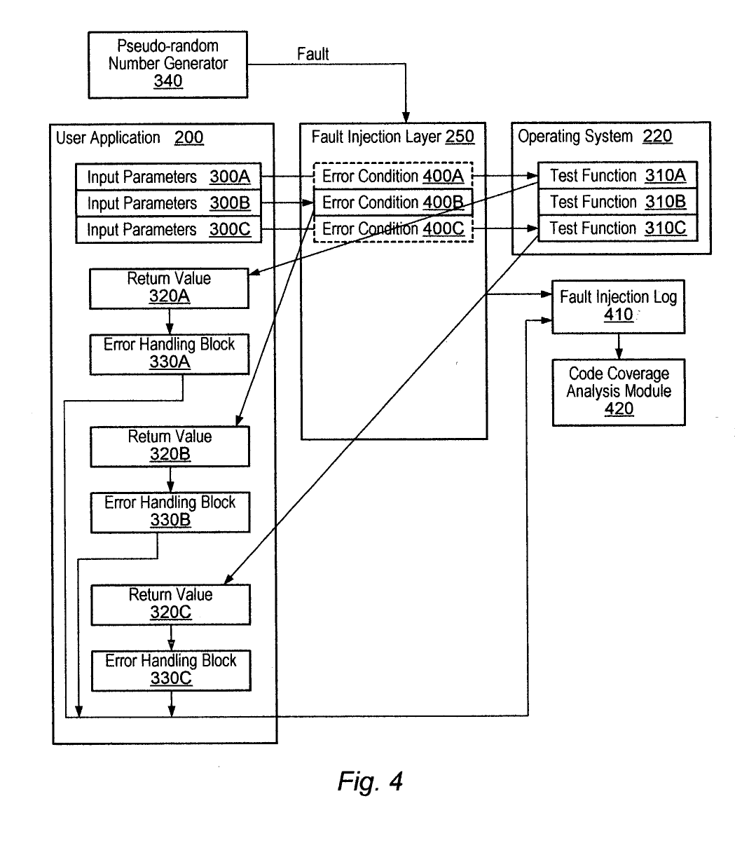

FIG. 4 illustrates one embodiment of fault injection layer 250 when operating in a non-transparent mode. In non-transparent mode, a function call from user application 200 to operating system 220 is intercepted by fault injection layer 250. Fault injection layer 250 thus prevents test function 310A-C from being called, and substitutes an error condition 400A-C for return value 320A-C. This substitute return value 320A-C may then trigger a specific response from error handling block 330A-C.

In one embodiment, error conditions 400A-C may be drawn from a set of all possible error codes associated with test functions 310A-C respectively. In various other embodiments, error conditions 400A-C may alternatively be a subset of all possible error codes, or may include codes that are not listed as error codes associated with test functions 400A-C.

As shown in FIG. 4, pseudo-random number generator 340 generates a pseudo-random number used to determine that fault injection layer 250 should intercept a function call to test function 310A-C. In various embodiments, different algorithms may be used to determine if the pseudo-random number should trigger a fault injection, including a numerical value threshold or a modulus trigger, for example. In additional embodiments, the same pseudo-random number input to various algorithms may control which calls test functions 310A-C are intercepted and which error conditions 400A-C are substituted for return values 320A-C. Alternatively, additional pseudo-random numbers may be generated to determine which test functions 310A-C are intercepted and which error conditions 400A-C are substituted.

Fault injection layer 250 is additionally operable to communicate with fault injection log 410, which may be operable to store a record of which faults have been injected by fault injection layer 250. In one embodiment, fault injection log 410 may additionally be operable to log which return values 320A-C have been returned to error handling blocks 330A-C, and what associated actions were taken by error handling blocks 330A-C. In one embodiment, fault injection log 410 may be operable to create no log entry when no fault injection has occurred.

Code coverage analysis module 420 is operable to communicate with fault injection log 410, and may be operable to determine which test functions 310A-C have been intercepted and which associated error codes 400A-C have been substituted. Likewise, code coverage analysis module 420 may be operable to determine which calls to test functions 310A-C have not been intercepted and which associated error codes 400A-C have not been substituted. It is noted that in one embodiment, code coverage analysis module 420 may be operable in conjunction with pseudo-random number generator 340 to form a testing map of what functionality of error handling blocks 330A-C has yet to be invoked, and to continue testing until that functionality has been invoked, as described below.

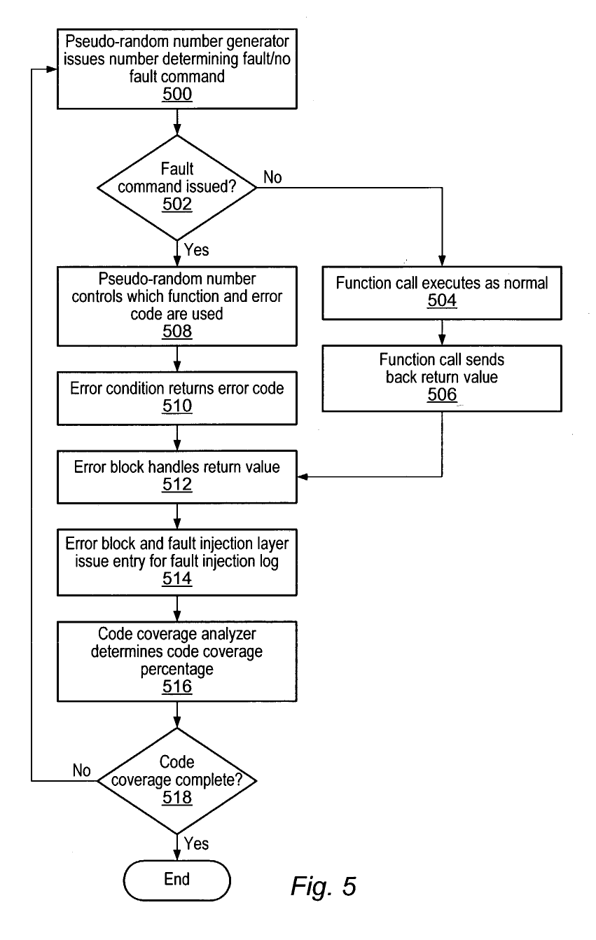

FIG. 5 is a flowchart illustrating one embodiment of a method for systematically testing the functionality of error handling blocks 330A-C. In step 500, pseudo-random number generator 340 generates a pseudo-random number which may be used to determine if fault injection layer 250 should inject a fault into the interface between user application 200 and operating system 220. In step 502, fault injection layer 250 determines if a fault should be injected, in accordance with the number generated in step 500.

If, in step 502, it is determined that no fault is to be injected, fault injection layer 250 advances to step 504, wherein it enters transparent mode and allows calls to test functions 310A-C to be made without interference. In step 506, the function call sends back the regular return values 320A-C associated with test functions 310A-C. Fault injection layer may then advance to step 512, as described below.

If step 502 determines that a fault is to be injected, fault injection layer 250 advances to step 508, wherein a pseudo-random number generated by pseudo-random number generator 340 determines which function and error code are to be injected. In one embodiment, pseudo-random number generator 340 may generate multiple numbers for steps 502 and 508, while in alternate embodiments, one or more numbers may be generated for each step. In step 510 the selected function call to test function 310A-C is intercepted by fault injection layer 250 and the selected error condition 400A-C is returned.

In step 512, the associated error block 330A-C handles the return value 320A-C of substituted error code 400A-C as described above in FIG. 3. In step 514, error handling block 330A-C and fault injection layer 250 issue an appropriate entry for error handling log 410. In step 516, code coverage analysis module 420 determines which error handling codes remain to be substituted, out of the set of all possible error codes associated with test functions 310A-C.

In step 518, code coverage analysis module 420 determines if a sufficient amount of error codes 400A-C have been covered. If a sufficient number of error codes 400A-C have been covered, the method may end. Alternatively, if additional error codes remain to be tested, fault injection layer 250 may return to step 500, wherein a new pseudo-random number is generated by pseudo-random number generator 340.

In one embodiment, code coverage analysis module 420 may base the decision in step 518 on whether a set percentage of total possible error codes 400A-C have been substituted. Alternatively, code coverage analysis module 420 may decide to continue in step 518 based on if a key subset of possible error conditions have been covered.

It is noted that, in one alternate embodiment, pseudo-random number generator 340 may not be used, and that code coverage analysis module 420 may directly control fault injection layer 250 to substitute error codes 400A-C that have not yet been substituted. It is also noted that, in one embodiment, pseudo-random number generator may generate a pseudo-random number based on a seed. In one embodiment, this seed may additionally be stored in fault injection log 410. In a further embodiment, the settings which control how often pseudo-random number generator 340 triggers a fault injection may be controlled by environmental variables, which may be modified by the end user.

In one embodiment, fault injection layer 250 may be further operable to alter input parameters 300A-C, thereby altering the behavior and return values of test functions 310A-C while still allowing test functions 310A-C to execute. In addition, code coverage analysis module may further be operable to track which input parameters 300A-C have been altered, and which input parameters 300A-C remain to be altered.

It is noted that, in various embodiments, fault injection layer 250 may be coupled to the interfaces between any plurality of software modules, such as operating system 220 and device drivers 230, for example. It is further noted that fault injection layer 250 may simultaneously be coupled to a plurality of interfaces between a plurality of software modules, thereby allowing multiple software modules to be tested at once.

Any of the embodiments described above may further include receiving, sending or storing instructions and/or data that implement the operations described above in conjunction with FIGS. 2-5 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a software module;
a function provider for providing designated functions in response to calls initiated by the software module;
an error handling block configured to respond to a plurality of error conditions; and
a fault injection layer operable to intercept a function call generated by said software module, thereby preventing a corresponding function from being performed by said function provider,
wherein said fault injection layer is further operable to return an error condition in response to said function call.

2. The system of claim 1 further comprising a pseudo-random number generator operable to generate a pseudo-random number, wherein said pseudo-random number is operable to control whether said fault injection layer intercepts said function call.

3. The system of claim 2 wherein said pseudo-random number generator is operable to generate additional pseudo-random numbers, wherein said additional pseudo-random numbers are further operable to control which of a plurality of function calls are intercepted by said fault injection layer, and
wherein said additional pseudo-random numbers are further operable to control which of a plurality of possible error conditions is returned by said fault injection layer.

4. The system of claim 2 further comprising a fault injection log operable to indicate particular function calls have been intercepted.

5. The system of claim 4 wherein said fault injection log is further operable to indicate which of a plurality of possible error conditions have been returned by said fault injection layer.

6. The system of claim 4 further comprising a code coverage analysis module operable to determine which of a total number of function calls remain to be intercepted.

7. The system of claim 6 wherein said code coverage analysis module is further operable to determine which of a plurality of possible error codes have yet to be returned by said fault injection layer.

8. The system of claim 1 wherein said fault-injection layer is operable in a transparent mode wherein function calls are provided to the function provider.

9. The system of claim 4 wherein said pseudo-random number generator is operable to generate said pseudo-random number based on a seed.

10. The system of claim 9 wherein said seed is stored in said fault injection log.

11. The system of claim 3 wherein a frequency of intercepted function calls is controlled by environment variables.

12. The system of claim 1 wherein said fault injection layer is further operable to modify one or more input parameters associated with said function call.

13. A method comprising:
initiating one or more function calls from a software module to a function provider;
intercepting said function calls with a fault injection layer, thereby preventing a corresponding function from being performed by said function provider;
returning an error condition from said fault injection layer to said software module in response to said function call;
responding to said error condition code with an error handling block.

14. The method of claim 13 further comprising generating a pseudo-random number, wherein said pseudo-random number is operable to control whether said fault injection layer intercepts said function call.

15. The method of claim 14 further comprising generating additional pseudo-random numbers, wherein said additional pseudo-random numbers are further operable to control which of a plurality of function calls are intercepted by said fault injection layer, and
wherein said additional pseudo-random numbers are further operable to control which of a plurality of possible error conditions is returned by said fault injection layer.

16. The method of claim 14 further comprising indicating which particular function calls have been intercepted in a fault injection log.

17. The method of claim 16 further comprising indicating which of a plurality of possible error conditions have been returned by said fault injection layer.

18. The method of claim 16 further comprising determining which of a total number of function calls remain to be intercepted.

19. The method of claim 18 further comprising determining which of a plurality of possible error codes have yet to be returned by said fault injection layer.

20. The method of claim 16 further comprising generating said pseudo-random number based on a seed.

21. The method of claim 20 wherein said seed is stored in said fault injection log.

22. The method of claim 15 further comprising controlling a frequency of intercepted function calls by environment variables.

23. A computer readable medium including program instructions executable to implement a method comprising:
initiating one or more function calls from a software module to a function provider;
intercepting said function calls with a fault injection layer, thereby preventing a corresponding function from being performed by said function provider;
returning an error condition from said fault injection layer to said software module in response to said function call;
responding to said error condition code with an error handling block.

24. The computer readable medium of claim 23 further comprising generating a pseudo-random number, wherein said pseudo-random number is operable to control whether said fault injection layer intercepts said function call.

25. The computer readable medium of claim 24 further comprising generating additional pseudo-random numbers, wherein said additional pseudo-random numbers are further operable to control which of a plurality of function calls are intercepted by said fault injection layer, and
wherein said additional pseudo-random numbers are further operable to control which of a plurality of possible error conditions is returned by said fault injection layer.

26. The computer readable medium of claim 23 further comprising operating said fault injection layer in a transparent mode wherein function calls are provided to the function provider.

27. The computer readable medium of claim 23 further comprising modifying one or more input parameters associated with said function call.
